(19) United States
(12) Patent Application Publication
(10) Pub. No.: US 2024/0354975 A1
(43) Pub. Date: Oct. 24, 2024

(54) TRAINING DATA SELECTION DEVICE FOR SELECTING TRAINING DATA TO IMPROVE PERFORMANCE OF A DEPTH ESTIMATION NETWORK AND A TRAINING DATA SELECTION METHOD THEREFOR

(71) Applicants: HYUNDAI MOTOR COMPANY, Seoul (KR); KIA CORPORATION, Seoul (KR)

(72) Inventors: Jin Sol Kim, Hwaseong-si (KR); Jin Ho Park, Seoul (KR); Jang Yoon Kim, Seoul (KR)

(73) Assignees: HYUNDAI MOTOR COMPANY, Seoul (KR); KIA CORPORATION, Seoul (KR)

(21) Appl. No.: 18/521,736

(22) Filed: Nov. 28, 2023

(30) Foreign Application Priority Data
Apr. 24, 2023 (KR) 10-2023-0053422

(51) Int. Cl. G06T 7/50

(52) U.S. Cl. CPC G06T 7/50

(57) ABSTRACT

A training data selection device for selecting training data and a training data selection method therefor are provided. The training data selection device includes a depth estimation network that applies depth estimation calculation to an input image obtained in real time to output depth distribution information corresponding to the input image. The device includes a vulnerability output device that outputs depth estimation vulnerability corresponding to the input image with reference to the depth distribution information. The device includes a training data acquisition support device that stores the input image and specific point cloud data corresponding to the input image as new training data in a certain storage space or transmits the input image and the specific point cloud data to another device, when it is determined that the depth estimation vulnerability is greater than or equal to a predetermined threshold.

### CROSS-REFERENCE TO RELATED APPLICATION

This application claims the benefit of priority to Korean Patent Application No. 10-2023-0053422, filed in the Korean Intellectual Property Office on Apr. 24, 2023, the entire contents of which are incorporated herein by reference.

### TECHNICAL FIELD

The present disclosure relates to a training data selection device for selecting training data to improve performance of a depth estimation network and a training data selection method therefor.

### BACKGROUND

A large amount of images and point cloud data are required to train a depth estimation network. The images and the point cloud data may be obtained in various manners. For example, images and point cloud data in various times and spaces may be obtained by means of a camera and light detection and ranging (LiDAR) mounted on a vehicle which travels on the road.

However, there is a problem that huge costs incur to store all images and point cloud data collected in real time by the vehicle while the vehicle is traveling.

To overcome the above-mentioned problem, a technology exists that stores an image and point cloud data collected when an environmental condition for storing the image and the point cloud data is met, in a state where the environmental condition is predefined.

However, when the above technology is used, the environmental condition should be considered for each time point when the image and the point cloud data are collected, and data corresponding to an environmental condition, which is not considered in advance, is not collected.

Thus, data necessary to improve performance of the depth estimation network is insufficiently collected/stored. Also, the improvement of the performance of the depth estimation network is seldom achieved.

### SUMMARY

The present disclosure has been made to solve the above-mentioned problems occurring in the prior art while advantages achieved by the prior art are maintained intact.

Aspects of the present disclosure provide a training data selection device for selecting training data of a depth estimation network and a training data selection method therefor.

Other aspects of the present disclosure provide a training data selection device for selecting training data capable of supplementing vulnerable performance of the depth estimation network and a training data selection method therefor.

Further aspects of the present disclosure provide a training data selection device for reducing a time and costs consumed to store and transmit training data and a training data selection method therefor.

The technical problems to be solved by the present disclosure are not limited to the aforementioned problems. Any other technical problems not mentioned herein should be more clearly understood from the following description by those having ordinary skill in the art to which the present disclosure pertains.

According to an aspect of the present disclosure, a training data selection device may include a depth estimation network that applies depth estimation calculation to an input image obtained in real time to output depth distribution information corresponding to the input image. The device may also include a vulnerability output device that outputs depth estimation vulnerability corresponding to the input image with reference to the depth distribution information. The device may also include a training data acquisition support device that stores the input image and specific point cloud data corresponding to the input image as new training data in a certain storage space or transmits the input image and the specific point cloud data to another device, when it is determined that the depth estimation vulnerability is greater than or equal to a predetermined threshold.

In an embodiment, the depth estimation network may perform a process of outputting j_1st to j_Kth probability values corresponding to 1st to Kth default depths for a jth pixel being any one of 1st to nth pixels of the input image with respect to the 1st to nth pixels to output probability values from 1_1st to 1_Kth probability values to n_1st to n_Kth probability values for the 1st to nth pixels as the depth distribution information.

In an embodiment, the vulnerability output device may generate 1st to nth predicted depth values of the 1st to nth pixels and 1st to nth offsets corresponding to the 1st to nth predicted depth values with reference to the probability values from the 1_1st to 1_Kth probability values to the n_1st to n_Kth probability values and the 1st to Kth default depths. The vulnerability output device may also output the depth estimation vulnerability with reference to the 1st to nth predicted depth values and the 1st to nth offsets.

In an embodiment, the vulnerability output device may also perform a process of generating a j_ith predicted depth value corresponding to an ith default depth with reference to an ith middle value determined on the basis of at least one default depth including the ith default depth and a j_ith probability value corresponding to the ith default depth for the jth pixel with respect to the 1st to Kth default depths to generate j_1st to j_Kth predicted depth values. The vulnerability output device may also perform a process of generating a jth predicted depth value of the jth pixel with reference to the j_1st to j_Kth predicted depth values with respect to the 1st to nth pixels to generate the 1st to nth predicted depth values.

In an embodiment, the vulnerability output device may perform a process of generating a j_ith offset corresponding to the ith default depth with reference to the ith middle value, the jth predicted depth value, and the j_ith probability value for the jth pixel with respect to the 1st to Kth default depths to generate j_1st to j_Kth offsets. The vulnerability output device may also perform a process of generating a jth offset of the jth pixel with reference to the j_1st to j_Kth offsets with respect to the 1st to nth pixels to generate the 1st to nth offsets.

In an embodiment, the training data acquisition support device may store point cloud data obtained in a first time interval set on the basis of a time point when the input image is obtained as the specific point cloud data in the certain storage space or may transmit the point cloud data to the other device.

In an embodiment, the depth estimation network may apply the depth estimation calculation to the input image to output the depth distribution information corresponding to the input image, in a state where a learning device applies the depth estimation calculation to beforehand training image to generate predicted depth distribution information corresponding to the beforehand training image. The depth estimation network may also generate a depth loss using the predicted depth distribution information and ground truth (GT) depth distribution information corresponding to the predicted depth distribution information. The depth estimation network may also perform back propagation of the depth loss to learn a parameter of the depth estimation network.

In an embodiment, the GT depth distribution information may be generated by applying point cloud data for training to an image coordinate system corresponding to the beforehand training image. The point cloud data may be obtained in a second time interval set on the basis of a time point when the beforehand training image is obtained.

According to another aspect of the present disclosure, a training data selection method may include applying depth estimation calculation to an input image obtained in real time to output depth distribution information corresponding to the input image. The method may also include outputting depth estimation vulnerability corresponding to the input image with reference to the depth distribution information. The method may also include storing the input image and specific point cloud data corresponding to the input image as new training data in a certain storage space or transmitting the input image and the specific point cloud data to another device, when it is determined that the depth estimation vulnerability is greater than or equal to a predetermined threshold.

In an embodiment, the outputting of the depth distribution information may include performing a process of outputting j_1st to j_Kth probability values corresponding to 1st to Kth default depths for a jth pixel being any one of 1st to nth pixels of the input image with respect to the 1st to nth pixels to output probability values from 1_1st to 1_Kth probability values to n_1st to n_Kth probability values for the 1st to nth pixels as the depth distribution information.

In an embodiment, the outputting of the depth estimation vulnerability may include generating 1st to nth predicted depth values of the 1st to nth pixels and 1st to nth offsets corresponding to the 1st to nth predicted depth values with reference to the probability values from the 1_1st to 1_Kth probability values to the n_1st to n_Kth probability values and the 1st to Kth default depths. The outputting of the depth estimation vulnerability may also include outputting the depth estimation vulnerability with reference to the 1st to nth predicted depth values and the 1st to nth offsets.

In an embodiment, the outputting of the depth estimation vulnerability may include performing a process of generating a j_ith predicted depth value corresponding to an ith default depth with reference to an ith middle value determined on the basis of at least one default depth including the ith default depth and a j_ith probability value corresponding to the ith default depth for the jth pixel with respect to the 1st to Kth default depths to generate j_1st to j_Kth predicted depth values. The outputting of the depth estimation vulnerability may also include performing a process of generating a jth predicted depth value of the jth pixel with reference to the j_1st to j_Kth predicted depth values with respect to the 1st to nth pixels to generate the 1st to nth predicted depth values.

In an embodiment, the outputting of the depth estimation vulnerability may include performing a process of generating a j_ith offset corresponding to the ith default depth with reference to the ith middle value, the jth predicted depth value, and the j_ith probability value for the jth pixel with respect to the 1st to Kth default depths to generate j_1st to j_Kth offsets. The outputting of the depth estimation vulnerability may also include performing a process of generating a jth offset of the jth pixel with reference to the j_1st to j_Kth offsets with respect to the 1st to nth pixels to generate the 1st to nth offsets.

In an embodiment, the storing of the input image and the specific point cloud data in the certain storage space or the transmitting of the input image and the specific point cloud data to the other device may include storing point cloud data obtained in a first time interval set on the basis of a time point when the input image is obtained as the specific point cloud data in the certain storage space or transmitting the point cloud data to the other device.

In an embodiment, the training data selection method may further include applying the depth estimation calculation to beforehand training image to generate predicted depth distribution information corresponding to the beforehand training image. The method may further include generating a depth loss using the predicted depth distribution information and GT depth distribution information corresponding to the predicted depth distribution information. The method may further include performing back propagation of the depth loss to learn a parameter of the depth estimation network, before outputting the depth distribution information.

In an embodiment, the GT depth distribution information may be generated by applying point cloud data for training to an image coordinate system corresponding to the beforehand training image. The point cloud data is obtained in a second time interval set on the basis of a time point when the beforehand training image is obtained.

### BRIEF DESCRIPTION OF THE DRAWINGS

The above and other objects, features, and advantages of the present disclosure should be more apparent from the following detailed description taken in conjunction with the accompanying drawings:

FIG. 1 is a block diagram illustrating a configuration of a training data selection device for selecting training data of a depth estimation network according to an embodiment of the present disclosure;

FIG. 2 is a flowchart for describing a training data selection method for selecting training data of a depth estimation network according to an embodiment of the present disclosure;

FIG. 3 is a drawing for describing a process of converting coordinates;

FIG. 4 is a drawing illustrating depth distribution information output as a depth estimation network applies depth estimation calculation to an input image;

FIG. 5 is a drawing illustrating 1st to Kth default depths set according to various embodiments of the present disclosure; and

FIGS. 6A, 6B, and 6C are drawings illustrating an input image, a per-pixel predicted depth value, and a per-pixel offset.

With regard to description of the drawings, the same or similar denotations may be used for the same or similar components throughout the drawings.

### DETAILED DESCRIPTION

Hereinafter, some embodiments of the present disclosure are described in detail with reference to the accompanying drawings. In adding the reference numerals to the components of each drawing, it should be noted that the identical or equivalent components are designated by the identical numerals even when the components are displayed on other drawings. Further, in describing the embodiments of the present disclosure, a detailed description of well-known features or functions has been omitted in order not to unnecessarily obscure the gist of the present disclosure.

In describing the components of the embodiment according to the present disclosure, terms such as first, second, “A”, “B”, (a), (b), and the like may be used. These terms are merely intended to distinguish one component from another component, and the terms do not limit the nature, sequence, or order of the corresponding components. Furthermore, unless otherwise defined, all terms including technical and scientific terms used herein have the same meaning as being generally understood by those having ordinary skill in the art to which the present disclosure pertains. Such terms as those defined in a generally used dictionary should be interpreted as having meanings consistent with to the contextual meanings in the relevant field of art. Such terms should not be interpreted as having ideal or excessively formal meanings unless clearly defined as having such in the present application.

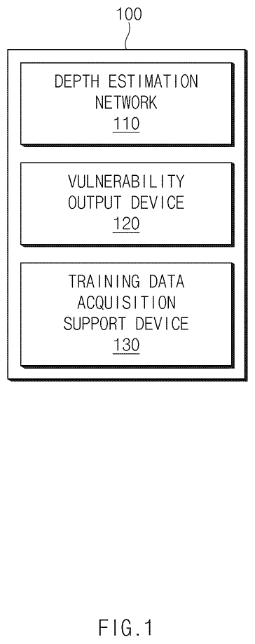

Hereinafter, embodiments of the present disclosure are described in detail with reference to FIGS. 1-6C.

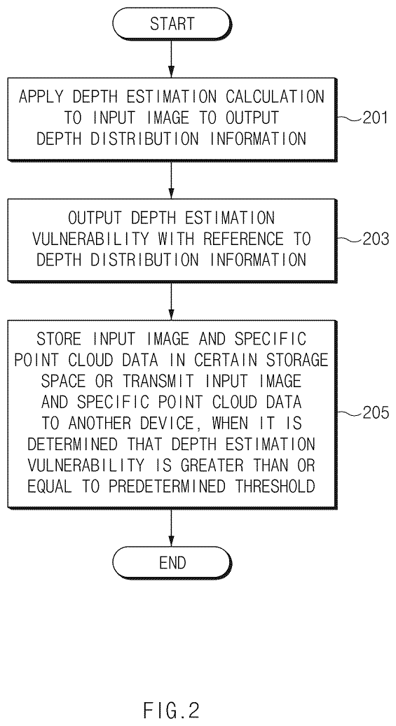

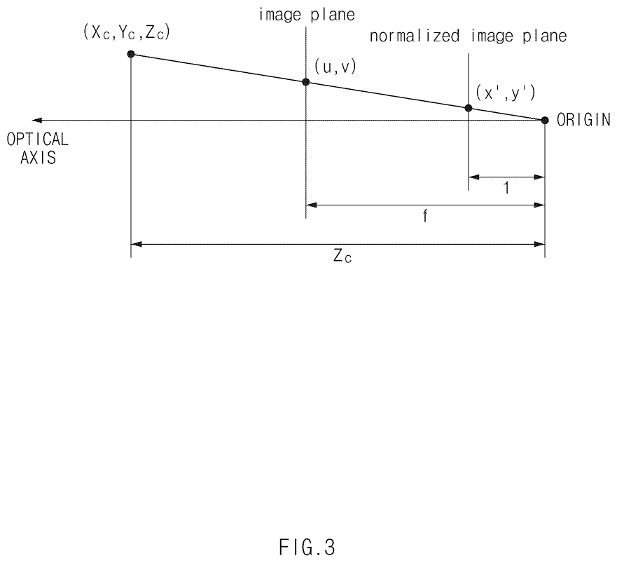

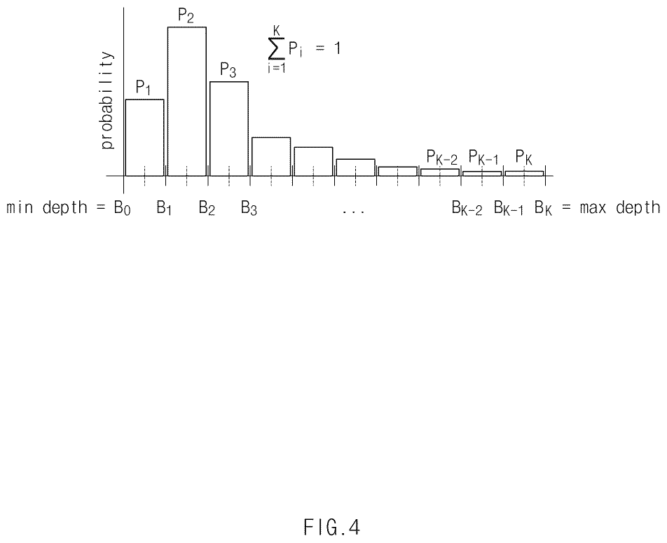

FIG. 1 is a block diagram illustrating a configuration of a training data selection device for selecting training data of a depth estimation network according to an embodiment of the present disclosure. FIG. 2 is a flowchart for describing a training data selection method for selecting training data of a depth estimation network according to an embodiment of the present disclosure. FIG. 3 is a drawing for describing a process of converting coordinates. FIG. 4 is a drawing illustrating depth distribution information output as a depth estimation network applies depth estimation calculation to an input image.

Referring to FIG. 1, a training data selection device 100 for selecting training data of a depth estimation network according to an embodiment of the present disclosure may include a depth estimation network 110, a vulnerability output device 120, and a training data acquisition support device 130.

FIG. 2 describes operations of the depth estimation network 110, the vulnerability output device 120, and the training data acquisition support device 130 included in the training data selection device 100 for selecting the training data of the depth estimation network according to an embodiment of the present disclosure.

Referring to FIG. 2, in step 201, the training data selection device 100 may apply depth estimation calculation to an input image to output depth distribution information corresponding to the input image.

At this time, the input image may be obtained in real time. For example, the input image may be obtained in real time by means of at least one camera mounted on a moving body, which travels on the road in various times and spaces.

In step 203, the vulnerability output device 120 may output depth estimation vulnerability corresponding to the input image with reference to the depth distribution information.

In step 205, the training data acquisition support device 130 may store the input image and specific point cloud data corresponding to the input image as new training data in a certain storage space or may transmit the input image and the specific point cloud data to another device, when it is determined that the depth estimation vulnerability is greater than or equal to a predetermined threshold.

For reference, although the depth estimation network is pre-trained using various pieces of training data, the depth estimation network may estimate an accurate depth for a first input image, whereas the depth estimation network may estimate an inaccurate depth for a second input image.

This corresponds to a phenomenon, which occurs because the depth estimation network does not sufficiently learn features included in the second input image. When such a depth estimation network is actually loaded into an autonomous vehicle or the like, there is an increase in risk that a safety accident may occur.

Thus, the training data selection device 100 according to an embodiment of the present disclosure may determine whether the depth estimation network 110, the training of which is performed, is vulnerable to any image, may collect the image to generate training data, and may train the depth estimation network 110. Thus, the performance of the depth estimation network 110 may be improved.

FIGS. 1 and 2 schematically describe the configuration and operation of the training data selection device for selecting the training data of the depth estimation network according to an embodiment of the present disclosure. Hereinafter, FIGS. 3, 4, and 5 describe an operation of the training data selection device for selecting the training data of the depth estimation network according to an embodiment of the present disclosure.

First of all, the training data selection device 100 may apply depth estimation calculation to the input image by means of the depth estimation network 110 to output depth distribution information corresponding to the input image.

At this time, the depth estimation network 110 may be in a state where it is already learned.

For example, a learning device may input a beforehand training image for pre-training the depth estimation network to the depth estimation network and may allow the depth estimation network to apply depth estimation calculation to the beforehand training image to generate predicted depth distribution information corresponding to the beforehand training image.

The learning device may generate a depth loss using the predicted depth distribution information and ground truth (GT) depth distribution information corresponding to the predicted depth distribution information.

At this time, the GT depth distribution information may be generated by applying point cloud data for training, which is obtained in a second time interval set on the basis of a time point when the beforehand training image is obtained, to an image coordinate system corresponding to the beforehand training image.

For example, as shown in FIG. 3, the learning device may convert coordinates (X_{c}, Y_{c}, Z_{c}) on the basis of a camera coordinate system into coordinates (x′, y′) on a normalized image plane and may convert the coordinates (x′, y′) on the normalized image plane into coordinates (u, v) on an image plane. For reference, the normalized image plane may be a virtual space where the focal length is “1” and may be converted in coordinates into the image plane by multiplying coordinates on the normalized image plane by an intrinsic matrix K. The converted coordinate value may correspond to a location of a pixel of an image. At this time, a Z-axis direction may be a direction a camera faces.

This may be represented as Equations 1, 2, and 3 below.

$${X}^{′} = \frac{{X}_{c}}{{Z}_{c}} , {y}^{′} = \frac{{Y}_{c}}{{Z}_{c}} \qquad [ Equation 1 ]$$

$$[ \begin{matrix}u \\ v \\ 1\end{matrix} ] = [ \begin{matrix}{f}_{x} & 0 & {0}_{x} \\ 0 & {f}_{y} & {0}_{y} \\ 0 & 0 & 1\end{matrix} ] [ \begin{matrix}x \\ y \\ 1\end{matrix} ] \qquad [ Equation 2 ]$$

$$K = [ \begin{matrix}{f}_{x} & 0 & {0}_{x} \\ 0 & {f}_{y} & {0}_{y} \\ 0 & 0 & 1\end{matrix} ] \qquad [ Equation 3 ]$$

Furthermore, the learning device may apply point cloud data to the image coordinate system by means of Equations 4 and 5 below to generate a depth estimation map.

$$\frac{1}{{Z}_{c}} [ \begin{matrix}{f}_{x} & 0 & {0}_{x} \\ 0 & {f}_{y} & {0}_{y} \\ 0 & 0 & 1\end{matrix} ] [ \begin{matrix}{r}_{11} & {r}_{12} & {r}_{13} & {t}_{1} \\ {r}_{21} & {r}_{22} & {r}_{23} & {t}_{2} \\ {r}_{31} & {r}_{32} & {r}_{33} & {t}_{3}\end{matrix} ] [ \begin{matrix}X \\ Y \\ Z \\ 1\end{matrix} ] \qquad [ Equation 4 ]$$

$${Z}_{c} = {r}_{31} X + {r}_{32} Y + {r}_{33} Z + {t}_{3} \qquad [ Equation 5 ]$$

The learning device may perform back propagation of the depth loss to learn a parameter of the depth estimation network.

In the state where the depth estimation network 110 is trained to some degree by performing the above process, the training data selection device 100 may input the input image to the depth estimation network 110 and may apply depth estimation calculation to the input image by means of the depth estimation network 110 to output depth distribution information corresponding to the input image.

For example, the training data selection device 100 may perform a process of outputting j_1st to j_Kth probability values corresponding to 1st to Kth default depths for a jth pixel, which is any one of 1st to nth pixels of the input image with respect to the 1st to nth pixels. Thus, probability values from 1_1st to 1_Kth probability values to n_1st to n_Kth probability values output as the depth distribution information.

For example, as shown in FIG. 4, the depth estimation network 110 may output j_1st to j_Kth probability values P₁ to P_{K} corresponding to 1st to Kth default depths B₁ to B_{K} for the jth pixel among the n pixels of the input image with depth W and height H. At this time, the sum of the j_1st to j_Kth probability values P₁ to P_{K} may be “1”.

For reference, the values output by the depth estimation network 110 may be probability values corresponding to the 1st to Kth default depths for each pixel, but an embodiment of the present disclosure is not limited thereto. For example, as the depth estimation network 110 outputs certain values corresponding to the 1st to Kth default depths for each pixel and applies normalization calculation to the certain values by means of a softmax function, the probability values corresponding to the 1st to Kth default depths may be generated.

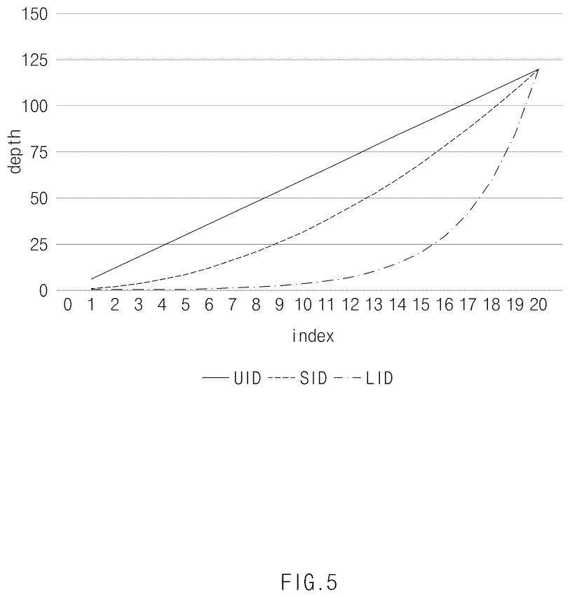

At this time, as shown in FIG. 5, the 1st to Kth default depths may be set by various embodiments of the present disclosure.

FIG. 5 is drawing illustrating 1st to Kth default depths set according to various embodiments of the present disclosure. For reference, it is assumed that the distance (or depth) from 0 m to 120 m is divided into 20 intervals (i.e., K=20).

For example, the 1st to Kth default depths may be set according to Equation 6 below. For reference, dₘᵢₙ may be 0.1 m and dₘₐₓ may be 120 m. Further, n_bins indicates the number of all the intervals and i indicates the index of the default depth.

$${d}_{i} = {d}_{min} + ( {d}_{max} - {d}_{min} ) \times i / {n}_{b i n s} \qquad [ Equation 6 ]$$

For another example, the 1st to Kth default depths may be set according to Equation 7 below. Likewise, dₘᵢₙ may be 0.1 m and dₘₐₓ may be 120 m.

$${d}_{i} = exp ( log ( {d}_{min} ) + \frac{log ( \frac{{d}_{max}}{{d}_{min}} ) \times i}{{n}_{b i n s}} ) \qquad [ Equation 7 ]$$

For another example, the 1st to Kth default depths may be set according to Equation 8 below. Likewise, dₘᵢₙ may be 0.1 m and dₘₐₓ may be 120 m.

$${d}_{i} = {d}_{min} + \frac{{d}_{max} - {d}_{min}}{{n}_{b i n s} ( {n}_{b i n s} + 1 )} \times i \times ( i + 1 ) \qquad [ Equation 8 ]$$

The 1st to Kth default depths set according to Equations 6, 7, and 8 above may be as shown in Table 1 below.

TABLE 1

| | Default depth | Default depth | Default depth |
|---|---|---|---|
| | according to | according to | according to |
| | Equation 6 above | Equation 7 above | Equation 8 above |
| Index of | (Uniform | (Spacing Increasing | (Linear Increasing |
| default | Discretization, | Discretization, | Discretization, |
| depth | UID) | SID) | LID) |
| 1 | 6.0950 | 0.1425 | 0.6710 |
| 2 | 12.0900 | 0.2032 | 1.8129 |
| 3 | 18.0850 | 0.2897 | 3.5257 |
| 4 | 24.0800 | 0.4129 | 5.8095 |
| 5 | 30.0750 | 0.5886 | 8.6643 |
| 6 | 36.0700 | 0.8390 | 12.0900 |
| 7 | 42.0650 | 1.1960 | 16.0867 |
| 8 | 48.0600 | 1.7048 | 20.6543 |
| 9 | 54.0550 | 2.4301 | 25.7929 |
| 10 | 60.0500 | 3.4641 | 31.5024 |
| 11 | 66.0450 | 4.9380 | 37.7829 |
| 12 | 72.0400 | 7.0390 | 44.6343 |
| 13 | 78.0350 | 10.0339 | 52.0567 |
| 14 | 84.0300 | 14.3030 | 60.0500 |
| 15 | 90.0250 | 20.3885 | 68.6143 |
| 16 | 96.0200 | 29.0633 | 77.7495 |
| 17 | 102.0150 | 41.4290 | 87.4557 |
| 18 | 108.0100 | 59.0559 | 97.7329 |
| 19 | 114.0050 | 84.1826 | 108.5810 |
| 20 | 120.0000 | 120.0000 | 120.0000 |

The training data selection device 100 may output depth estimation vulnerability corresponding to the input image with reference to the depth distribution information by means of a vulnerability output device 120.

For example, the training data selection device 100 may generate 1st to nth predicted depth values of 1st to nth pixels and 1st to nth offsets corresponding to the 1st to nth predicted depth values with reference to i) probability values from 1_1st to 1_Kth probability values to n_1st to n_Kth probability values and ii) 1st to nth default depths. The training data selection device 100 may also output the depth estimation vulnerability with reference to the 1st to nth predicted depth values and the 1st to nth offsets.

For example, as shown in Equation 9 below, the training data selection device 100 may perform a process of generating j_ith predicted depth value (Pᵢ*(Bᵢ₋₁+Bᵢ)/2) corresponding to ith default depth Bᵢ with reference to (i) an ith middle value ((Bᵢ₋₁+Bᵢ)/2) determined on the basis of at least one default depth (Bᵢ₋₁, Bᵢ) including the ith default depth Bᵢ and (ii) a j_ith probability value Pᵢ corresponding to the ith default depth Bᵢ for a jth pixel with respect to the 1st to Kth default depths. Thus, j_1st to j_Kth predicted depth values (P₁*(B₀+B₁)/2) to (P_{K}*(B_{K-1}+B_{K})/2) may be generated. The training data selection device 100 may perform a process of generating a jth predicted depth value E (X) of the jth pixel with reference to the j_1st to j_Kth predicted depth values (P₁*(B₀+B₁)/2) to (P_{K}*(B_{K-1}+B_{K})/2) with respect to the 1st to nth pixels to generate 1st to nth predicted depth values respectively corresponding to the 1st to nth pixels.

$$depth = E ( X ) = {\sum }_{i = 1}^{K} ( {P}_{i} \times \frac{( {B}_{i - 1} + {B}_{i} )}{2} ) \qquad [ Equation 9 ]$$

For reference, as shown in Equation 9 above, the ith middle value may be an average value of 1st to i_1st default depths Bᵢ to Bᵢ₋₁. However, the average value as the ith middle value is only one example, and an embodiment of the present disclosure is not limited thereto. For example, the ith middle value may be any value between the i_1st default depth Bᵢ₋₁ and the ith default depth Bᵢ.

Furthermore, as shown in Equation 10 below, the training data selection device 100 may perform a process of generating a j_1st offset corresponding to the ith default depth Bᵢ with reference to the ith middle value ((Bᵢ₋₁+Bᵢ)/2), the jth predicted depth value depth, and the j_ith probability value Pᵢ for the jth pixel with respect to the 1st to Kth default depths to generate j_1st to j_Kth offsets. The training data selection device 100 may also perform a process of generating a jth offset σ² of the jth pixel with reference to the j_1st to j_Kth offsets with respect to the 1st to nth pixels to generate 1st to nth offsets.

$${σ}^{2} = {\sum }_{i = 1}^{K} ( {( \frac{( {B}_{i - 1} + {B}_{i} )}{2} - dept 𝒽 )}^{2} \times {P}_{i} ) \qquad [ Equation 10 ]$$

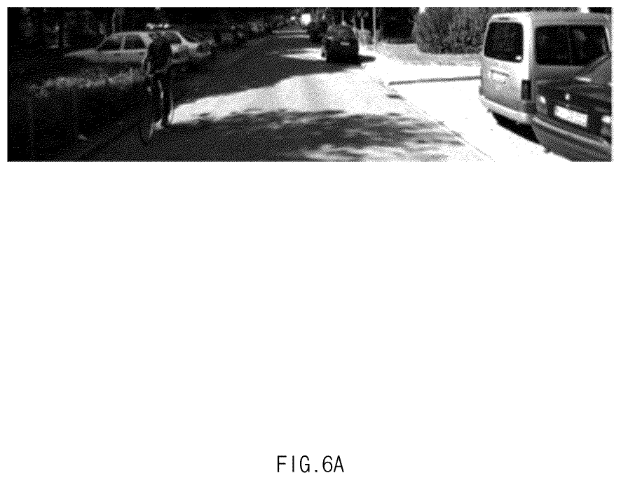

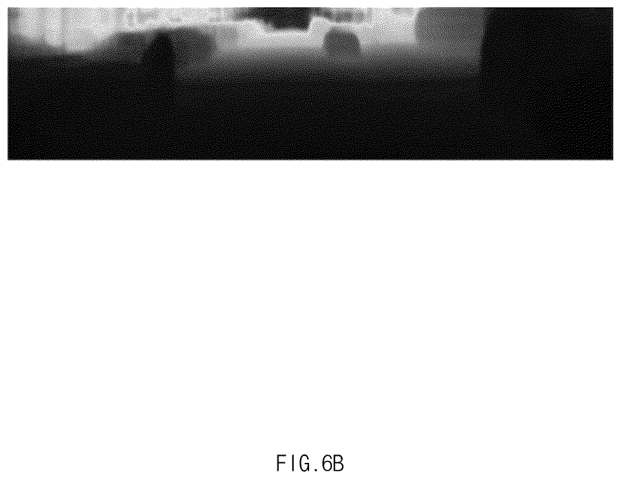

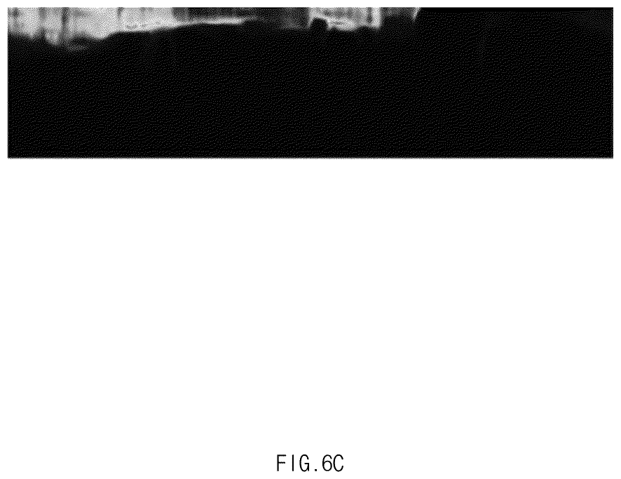

FIGS. 6A, 6B, and 6C are drawings illustrating an input image, a per-pixel predicted depth value, and a per-pixel offset.

A per-pixel predicted depth value generated with reference to depth distribution information output as depth estimation calculation is applied to an input image shown in FIG. 6A may be identified by means of FIG. 6B. A per-pixel offset generated with reference to the depth distribution information may be identified by means of FIG. 6C. Referring to FIG. 6C, it may be identified whether an offset is larger in (i.e., whether inaccurate depth any of the input image estimation is performed).

As described above, when the 1st to nth predicted depth values of the 1st to nth pixels are generated and when the 1st to nth offsets of the 1st to nth pixels are generated, a vulnerability output device 120 may output depth estimation vulnerability with reference to the 1st to nth predicted depth values and the 1st to nth offsets.

For example, the vulnerability output device 120 may output the depth estimation vulnerability depending on Equation 11 below.

$$Depth estimation vulnerability = {\sum }_{𝒽 = 1}^{H} {\sum }_{w = 1}^{W} \frac{{σ}_{𝒽 , w}}{{μ}_{𝒽 , w}} \qquad [ Equation 11 ]$$

For reference, μ indicates the predicted depth value of the specific pixel, and σ indicates the offset of the specific pixel. In other words, according to Equation 11 above, the vulnerability output device 120 may calculate how large the offset of the specific pixel is compared to the predicted depth value of the specific pixel and may add them for the entire input image. Thus, the depth estimation vulnerability is output.

When there is a tendency where a per-pixel offset is greater than a per-pixel predicted depth value of the input image, the value of the depth estimation vulnerability corresponding to the input image may increase. On the other hand, when there is a tendency where the per-pixel offset is less than the per-pixel predicted depth value of the input image, the value of the depth estimation vulnerability corresponding to the input image may decrease.

When it is determined that the depth estimation vulnerability is greater than or equal to a predetermined threshold, the training data selection device 100 may store the input image and specific point cloud data corresponding to the input image as new training data in a certain storage space. Alternatively, the training data selection device 100 may transmit the input image and the specific point cloud data to another device, by means of the training data acquisition support device 130.

At this time, the training data selection device 100 may store point cloud data obtained in a first time interval set on the basis of a time point when the input image is obtained as the specific point cloud data in the certain storage space (e.g., a data storage space loaded into a vehicle which travels on the road). Alternatively, the training data selection device 100 may transmit the point cloud data to another device (e.g., a server which collects training data).

As a result, the training data selection device 100 may select a specific image necessary to improve performance of the depth estimation network, in a situation where a large amount of images and a large amount of point cloud data are collected in real time. The training data selection device 100 may also store the specific image and specific point cloud data corresponding to the specific image in the storage space. Alternatively, the training data selection device 100 may transmit the specific image and the specific point cloud data to the other device. Thus, a time and costs consumed to store and transmit training data may be reduced.

The present technology may provide the training data selection device for selecting the training data of the depth estimation network and the training data selection method therefor.

Furthermore, the present technology may provide the training data selection device for selecting training data capable of supplementing vulnerable performance of the depth estimation network and the training data selection method therefor.

Furthermore, the present technology may provide the training data selection device for reducing a time and costs consumed to store and transmit training data and the training data selection method therefor.

In addition, various effects ascertained directly or indirectly through the present disclosure may be provided.

Hereinabove, although the present disclosure has been described with reference to embodiments and the accompanying drawings, the present disclosure is not limited thereto. The embodiments of the present disclosure may be variously modified and altered by those having ordinary skill in the art to which the present disclosure pertains without departing from the spirit and scope of the present disclosure claimed in the following claims.

Therefore, the embodiments of the present disclosure are provided to explain the spirit and scope of the present disclosure not to limit the present disclosure. Thus, the spirit and scope of the present disclosure is not limited by the embodiments. The scope of the present disclosure should be construed on the basis of the accompanying claims, and all the technical ideas within the scope equivalent to the claims should be included in the scope of the present disclosure.

What is claimed is:

1. A training data selection device, comprising:
a depth estimation network configured to apply depth estimation calculation to an input image obtained in real time to output depth distribution information corresponding to the input image;
a vulnerability output device configured to output depth estimation vulnerability corresponding to the input image with reference to the depth distribution information; and
a training data acquisition support device configured to store the input image and specific point cloud data corresponding to the input image as new training data in a certain storage space or configured to transmit the input image and the specific point cloud data to another device, when it is determined that the depth estimation vulnerability is greater than or equal to a predetermined threshold.

2. The training data selection device of claim 1, wherein the depth estimation network performs a process of outputting j_1st to j_Kth probability values corresponding to 1st to Kth default depths for a jth pixel being any one of 1st to nth pixels of the input image with respect to the 1st to nth pixels to output probability values from 1_1st to 1_Kth probability values to n_1st to n_Kth probability values for the 1st to nth pixels as the depth distribution information.

3. The training data selection device of claim 2, wherein the vulnerability output device is further configured to:
generate 1st to nth predicted depth values of the 1st to nth pixels and 1st to nth offsets corresponding to the 1st to nth predicted depth values with reference to the probability values from the 1_1st to 1_Kth probability values to the n_1st to n_Kth probability values and the 1st to Kth default depths; and
output the depth estimation vulnerability with reference to the 1st to nth predicted depth values and the 1st to nth offsets.

4. The training data selection device of claim 3, wherein the vulnerability output device is further configured to:
perform a process of generating a j_ith predicted depth value corresponding to an ith default depth with reference to an ith middle value determined on the basis of at least one default depth including the ith default depth and a j_ith probability value corresponding to the ith default depth for the jth pixel with respect to the 1st to Kth default depths to generate j_1st to j_Kth predicted depth values; and
perform a process of generating a jth predicted depth value of the jth pixel with reference to the j_1st to j_Kth predicted depth values with respect to the 1st to nth pixels to generate the 1st to nth predicted depth values.

5. The training data selection device of claim 4, wherein the vulnerability output device is further configured to:
perform a process of generating a j_ith offset corresponding to the ith default depth with reference to the ith middle value, the jth predicted depth value, and the j_ith probability value for the jth pixel with respect to the 1st to Kth default depths to generate j_1st to j_Kth offsets; and
perform a process of generating a jth offset of the jth pixel with reference to the j_1st to j_Kth offsets with respect to the 1st to nth pixels to generate the 1st to nth offsets.

6. The training data selection device of claim 1, wherein the training data acquisition support device is further configured to store point cloud data obtained in a first time interval set on the basis of a time point when the input image is obtained as the specific point cloud data in the certain storage space or further configured to transmit the point cloud data to the other device.

7. The training data selection device of claim 1, wherein the depth estimation network is further configured to:
apply the depth estimation calculation to the input image to output the depth distribution information corresponding to the input image, in a state where a learning device applies the depth estimation calculation to beforehand training image to generate predicted depth distribution information corresponding to the beforehand training image;
generate a depth loss using the predicted depth distribution information and ground truth (GT) depth distribution information corresponding to the predicted depth distribution information; and
perform back propagation of the depth loss to learn a parameter of the depth estimation network.

8. The training data selection device of claim 7, wherein:
the GT depth distribution information is generated by applying point cloud data for training to an image coordinate system corresponding to the beforehand training image; and
the point cloud data is obtained in a second time interval set on the basis of a time point when the beforehand training image is obtained.

9. A training data selection method, comprising:
applying depth estimation calculation to an input image obtained in real time to output depth distribution information corresponding to the input image;
outputting depth estimation vulnerability corresponding to the input image with reference to the depth distribution information; and
storing the input image and specific point cloud data corresponding to the input image as new training data in a certain storage space or transmitting the input image and the specific point cloud data to another device, when it is determined that the depth estimation vulnerability is greater than or equal to a predetermined threshold.

10. The training data selection method of claim 9, wherein the outputting of the depth distribution information includes:
performing a process of outputting j_1st to j_Kth probability values corresponding to 1st to Kth default depths for a jth pixel being any one of 1st to nth pixels of the input image with respect to the 1st to nth pixels to output probability values from 1_1st to 1_Kth probability values to n_1st to n_Kth probability values for the 1st to nth pixels as the depth distribution information.

11. The training data selection method of claim 10, wherein the outputting of the depth estimation vulnerability also includes:
generating 1st to nth predicted depth values of the 1st to nth pixels and 1st to nth offsets corresponding to the 1st to nth predicted depth values with reference to the probability values from the 1_1st to 1_Kth probability values to the n_1st to n_Kth probability values and the 1st to Kth default depths; and
outputting the depth estimation vulnerability with reference to the 1st to nth predicted depth values and the 1st to nth offsets.

12. The training data selection method of claim 11, wherein the outputting of the depth estimation vulnerability also includes:
performing a process of generating a j_ith predicted depth value corresponding to an ith default depth with reference to an ith middle value determined on the basis of at least one default depth including the ith default depth and a j_ith probability value corresponding to the ith default depth for the jth pixel with respect to the 1st to Kth default depths to generate j_1st to j_Kth predicted depth values; and
performing a process of generating a jth predicted depth value of the jth pixel with reference to the j_1st to j_Kth predicted depth values with respect to the 1st to nth pixels to generate the 1st to nth predicted depth values.

13. The training data selection method of claim 12, wherein the outputting of the depth estimation vulnerability also includes:
performing a process of generating a j_ith offset corresponding to the ith default depth with reference to the ith middle value, the jth predicted depth value, and the j_ith probability value for the jth pixel with respect to the 1st to Kth default depths to generate j_1st to j_Kth offsets; and
performing a process of generating a jth offset of the jth pixel with reference to the j_1st to j_Kth offsets with respect to the 1st to nth pixels to generate the 1st to nth offsets.

14. The training data selection method of claim 9, wherein the storing of the input image and the specific point cloud data in the certain storage space or the transmitting of the input image and the specific point cloud data to the other device includes:
storing point cloud data obtained in a first time interval set on the basis of a time point when the input image is obtained as the specific point cloud data in the certain storage space or transmitting the point cloud data to the other device.

15. The training data selection method of claim 9, further comprising:
applying the depth estimation calculation to beforehand training image to generate predicted depth distribution information corresponding to the beforehand training image;
generating a depth loss using the predicted depth distribution information and GT depth distribution information corresponding to the predicted depth distribution information; and
performing back propagation of the depth loss to learn a parameter of a depth estimation network, before outputting the depth distribution information.

16. The training data selection method of claim 15, wherein:
the GT depth distribution information is generated by applying point cloud data for training to an image coordinate system corresponding to the beforehand training image; and
the point cloud data is obtained in a second time interval set on the basis of a time point when the beforehand training image is obtained.
